(19) United States
(12) Patent Application Publication
(10) Pub. No.: US 2004/0252328 A1
(43) Pub. Date: Dec. 16, 2004

(54) System and method for processing print jobs and search queries

(75) Inventor: Satoshi Kaiho, Kanagawa-ken (JP)

Correspondence Address: FOLEY AND LARDNER, SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 10/458,620

(22) Filed: Jun. 11, 2003

(51) Int. Cl. B41J 1/00; B41B 1/00; G06F 15/16

(52) U.S. Cl. 358/1.15; 709/246

(57) ABSTRACT

A system and method for printing data includes receiving data to be printed from a user via a network connection, generating a unique identifier in response to the reception of the data from the user, the unique identifier being related to the received data and transmitting the unique identifier to the user via the network connection. The received data is translated into a printable format in accordance with a format suitable for a printing device on which the received data is to be printed. The received data in the printable format is then transmitted to the printing device on which the received data is to be printed. The system and method can also be configured to process search queries.

### FIELD OF THE INVENTION

The present invention relates generally to a data processing system, and more particularly to a system and method for processing print jobs and search queries.

### BACKGROUND OF THE INVENTION

In conventional arrangements for printing data, it takes time for the image forming or hardcopy device to print electronic data received from a data source, such as a user workstation. A substantial part of the time taken to print the data derives from the time required by the image forming or hardcopy device to convert the data into a printable format. This time taken to convert the data can result in a significant delay to the operations of some users, such as shop owners that require high printing rates.

Conventional retrieval systems typically include an input device for inputting a search query, a retrieval component which identifies and retrieves information responsive to the search query, and an output device for outputting the retrieved information. While the search query is being processed, no other operations can be performed by the input device, retrieval component or output device. Although the operation time is not long for completing the processing of a search query, the tying up of each component of the retrieval system during the processing causes processing delays.

It would therefore be desirable for a system to reduce the inefficiencies and time loss when printing data and processing search queries.

### SUMMARY OF THE INVENTION

Briefly, in one aspect of the invention, a system and method for printing data includes receiving data to be printed from a user via a network connection, generating a unique identifier in response to the reception of the data from the user, the unique identifier being related to the received data and transmitting the unique identifier to the user via the network connection. The received data is translated into a printable format in accordance with a format suitable for a printing device on which the received data is to be printed. The received data in the printable format is then transmitted to the printing device on which the received data is to be printed.

Further features, aspects and advantages of the present invention will become apparent from the detailed description of preferred embodiments that follows, when considered together with the accompanying figures of drawing.

### BRIEF DESCRIPTION OF THE DRAWINGS

FIG. 1 is a block diagram of a data processing system consistent with the present invention.

FIG. 2 is a more detailed block diagram of the management system of FIG. 1.

FIGS. 3A and 3B are flow diagrams of a process for printing data consistent with the present invention.

FIG. 4 is a block diagram of another data processing system consistent with the present invention.

FIGS. 5A-5C are flow diagrams of a process for managing and processing search queries consistent with the present invention.

### DETAILED DESCRIPTION OF PREFERRED EMBODIMENTS

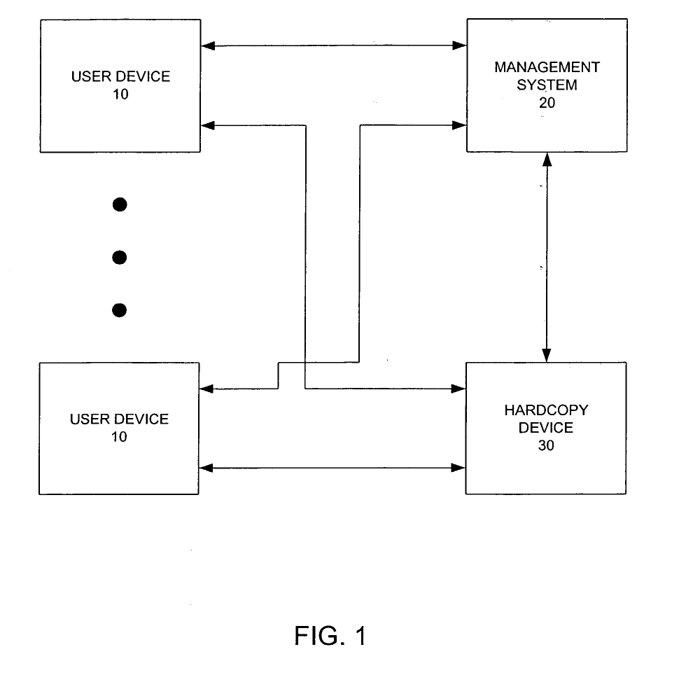

FIG. 1 is a block diagram of a data processing system consistent with the present invention. As shown in FIG. 1, the data processing system includes one or more user devices 10, a management system 20 and a hardcopy device 30. Each of these components can be coupled together by a network connection or by a direct communication connection. The network connection may be implemented by a local network, such as a LAN, or a public network, such as the Internet.

The user device 10 may be a PC, a mobile phone, a PDA, a magnetic card or some combination thereof. The user device 10 preferably includes a CPU, a main memory, a ROM, a storage device and a communication interface all coupled together via a bus. The CPU may be implemented as a single microprocessor or as multiple processors for a multi-processing system. The main memory is preferably implemented with a RAM and a smaller-sized cache. The ROM is a non-volatile storage, and may be implemented, for example, as an EPROM or NVRAM. The storage device can be a hard disk drive or any other type of non-volatile, writable storage.

The communication interface for the user device 10 provides a two-way data communication coupling, such as to a network. For example, if the communication interface is an integrated services digital network (ISDN) card or a modem, the communication interface provides a data communication connection to the corresponding type of telephone line. If the communication interface is a local area network (LAN) card, the communication interface provides a data communication connection to a compatible LAN. Wireless links are also possible. In any such implementation, the communication interface sends and receives electrical, electromagnetic or optical signals, which carry digital data streams representing different types of information.

If the network connection is an Internet connection, the user device 10 can transmit a requested code for an application program through the Internet, an ISP, the local network and the communication interface. The received code can be executed by the CPU in the user device 10 as it is received, stored in the storage device, or stored in some other non-volatile storage for later execution. In this manner, the user device 10 may obtain application code in the form of a carrier wave.

The hardcopy device 30 is a device which can perform the function of, for example, a printer, a fax machine, a copier, a plotter, a scanner or any other functional device that generates or processes images or text. Hardcopy devices 30 can also be devices, such as multi-function peripherals (MFPs), which are capable of performing the functions of two or more image processing devices, such as a combination of any of printing, faxing, copying, plotting and scanning. Like the user device 10, the hardcopy device 30 may have a CPU, a main memory, a ROM, a storage device and a communication interface all coupled together via a bus. The hardcopy device 30 may also have a communication interface to provide a two-way data communication coupling via a network link to a network. The network link enables the hardcopy device 30 to receive data from and to output data to the user device 10 or management system 20. Instead of a network link, hardcopy devices 30 may use a Universal Serial Bus (USB) or other direction communication link to connect to the user device 10 or the management system 20.

In operation, the user device 10 communicates with the management system 20 and the hardcopy device 30 via the network connection or via a more direct connection, such as the USB. This communication enables the user device 10 to request the management system 20 and the hardcopy device 30 to perform functions. With respect to the hardcopy device 30, the functions may include printing a document or sending or receiving a fax. In addition, the user device 10 can request information from the management system 20 and the hardcopy device 30.

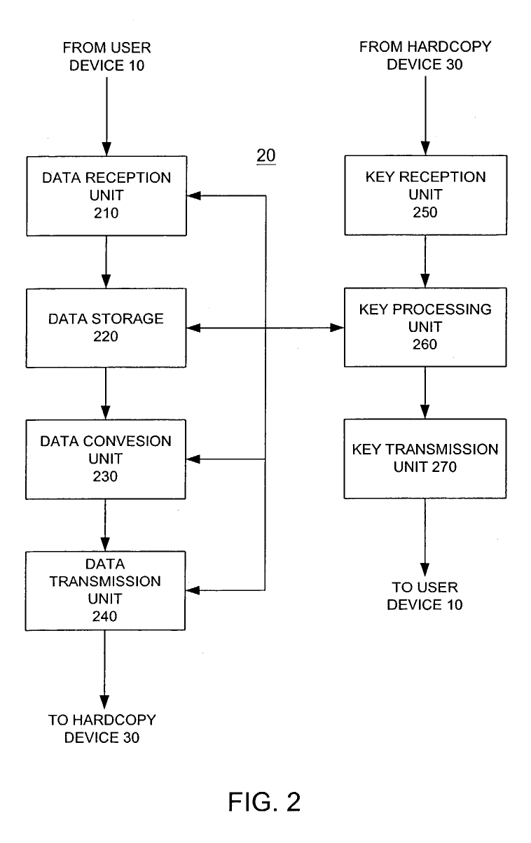

FIG. 2 is a more detailed block diagram of the management system of FIG. 1. As shown in FIG. 2, the management system 20 includes a data reception unit 210, a data storage 220, a data conversion unit 230, a data transmission unit 240, a key reception unit 250, a key processing unit 260 and a key transmission unit 270. The data reception unit 210 is a communication link of the management system 20 and is configured to received data from the user device 10. The data reception unit 210 can be connected to the user device 10 by a direct communication link or by a network connection. The data received can be, for example, a file or other set of data to be printed at a hardcopy device 30.

The data storage 220 receives and stores the data received by the data reception unit 210. The data storage 220 is preferably implemented as a non-volatile storage, such as NVRAM or hard disk drive. Each set of data received from a user device 220 is stored in a separate location and preferably includes a name or other identifier linked to the particular set of data. The data conversion unit 230 converts the data stored in the data storage 220 into a printable format. The data conversion unit 230 is capable of converting the data into any print format in accordance with the hardcopy device 30 on which the data is to be printed. The data transmission unit 240 transmits the data converted into a printable format to a hardcopy device 30 for printing. The data transmission unit 240 is also a communication link of the management system 20 and can be connected to a hardcopy device 30 by a direct communication link or by a network connection.

The key reception unit 250 receives a key, described in more detail below; from the hardcopy device 30. The key reception unit 250 is another communication link of the management system 20. The key processing unit 260 performs two functions for the management system 20. A first function is to generate keys. A key is generated from a particular set of data or data file received by the data reception unit 210 and stored in the data storage 220. The key itself is a unique identifier linked to the data stored in the data storage 220 and can be implemented, for example, as a bar code or numerical number. The key may also include the name or identifier of the set of data to which it is linked.

The second function of the key processing unit 260, as described in more detail below, is to receive a key from the key reception unit 250, determine which set of data in the data storage 220 is linked to the received key, determine which printable format to use and communicate to the data storage 220 and data conversion unit 230 the determined information. The second function can also include identifying the hardcopy device 30 to which the data transmission unit 240 is to transmit the data converted by the data conversion unit 230 and communicating the identity of the hardcopy device 30 to the data transmission unit 240. Alternatively, it is possible for the data received by the data reception unit 210 to include information identifying the hardcopy device 30 to which the data converted by the data conversion unit 230 is to be transmitted.

The key generated by the key processing unit 260 is forwarded to the key transmission unit 270. The key transmission unit 270 transmits the key to the user device that transmitted the data to the data reception unit 210. The key transmission unit is also a communication link of the management system 20 and can be connected to a hardcopy device 30 by a direct communication link or by a network connection.

These components of the management system 20 may all be implemented on a computer processing device, such as a PC or server, having one or more CPUs, volatile and non-volatile storage and communication devices and links. In addition, although described as separate elements, it should be understood that the data reception unit 210, data transmission unit 240, key reception unit 250 and key transmission unit 270 may all be implemented as a single communication device for receiving and transmitting data, such as a network card, modem or serial link. It is also possible for the management system 20 and the hardcopy device 30 to all be implemented as a single device, such as a multi-function peripheral (MFP) having document management system capabilities.

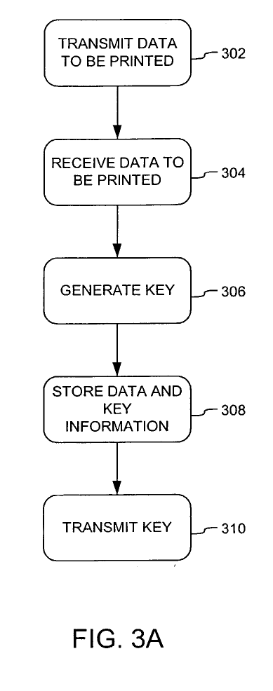

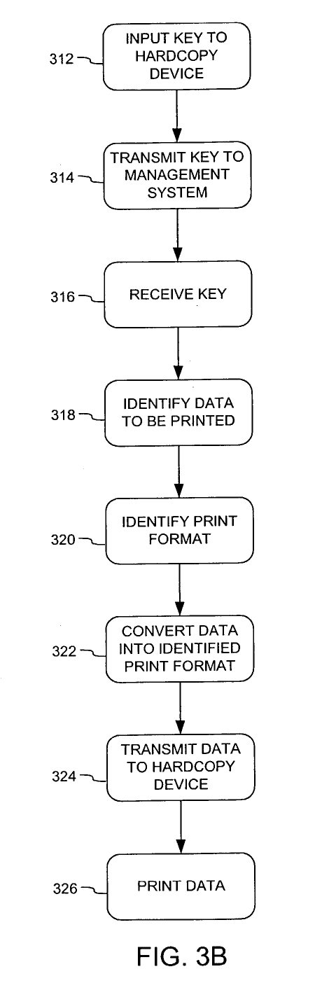

FIGS. 3A and 3B are flow diagrams of a process for printing data consistent with the present invention. As shown in FIG. 3A, a user transmits data to be printed to the management system 20 (step 302). The data is transmitted from a user device 10 to the data reception unit 210 of the management system 20 via a communication link, such as a network or direct connection. For example, if the user device 10 is a PC, the user can transmit the data via a network connection. If the user device 10 is a mobile telephone, the user can transmit the data via a wireless connection. The data transmitted by the user from the user device 10 is data to be printed at a hardcopy device 30. The data may also include information identifying the hardcopy device 30 on which the data is to be printed.

The data transmitted by the user is received by the data reception unit 210 of the management system 20 (step 304). The received data is then used to generate a key (step 306) and stored in the data storage 220 of the management system 20 (step 308). The key is generated by the key processing unit 260. The key can be generated by reference to the data received by the data reception unit 210 or by the data stored in the data storage 220. As described above, the key is a unique identifier linked to a particular set of data, such as a data file, received by the management system 20.

As also described above, each set of data stored in the data storage 220 is stored in a separate location and preferably includes a name or other identifier linked to the particular set of data. In addition to storing the data, the data storage 220 preferably includes a table that links each particular set of data to a key generated by the key processing unit 260. For example, the table can include two columns, with one column for the name of the set of data and the other column for the key linked to the set of data. This table can be used, as described below, to identify which set of data corresponds to a key received by the key reception unit 250.

The key generated by the key processing unit 260 is then transmitted to the user (step 310). The key is transmitted by the key transmission unit 270 to the user device 10 that transmitted the set of data to which the key is linked. The key transmitted to the user device 10 may be stored in a non-volatile storage area in the user device 10. The non-volatile storage area can be, for example, an NVRAM of a PC, mobile telephone or PDA or on a strip of a magnetic card.

Referring to FIG. 3B, in another aspect of the printing process, the user inputs the key received from the management system 20 to a hardcopy device 30 (step 312). The manner in which the user inputs the key depends upon the implementation of the user device 10 upon which the key is stored. For example, if the key is stored on a magnetic card, the user can input the key by swiping the card on a card reader implemented on the hardcopy device 30. Alternatively, if the user device 10 is a PDA, the user can input the key by placing the PDA on a cradle implemented on the hardcopy device 30 or by connecting a cable to link the PDA and the hardcopy device 30. The user device 10 and hardcopy device 30 can also be coupled together via a wireless link, e.g., an infrared link.

If more than one set of data to be printed was transmitted to the management system 20, then it is possible that the user device 10 may have more than one key. In this case, each of the keys stored in the user device 10 may be inputted to the hardcopy device 30. The hardcopy device 30 can then list each of the keys to the user, and the user selects which key to be printed. To facilitate this listing, as described above, the key may include a name or identifier of the set of data to be printed. If included, the name or identifier can be displayed to the user so the user knows which set of data will be printed based on the user's selection. Without the name or identifier, the user may not be able to easily determine which set of data corresponds to which key, which may simply be a unique numerical value.

The key received by the hardcopy device 30 is transmitted to the management system 20 (step 314). The key is transmitted to the management system 20 in accordance with the communication link between the management system 20 and the hardcopy device 30. The communication link may be a network connection, such as via the Internet or LAN, or a direct connection, such as USB. The key is received by the key reception unit 250 of the management system 20 (step 316). In addition to the key, the management system 20 may receive information identifying the hardcopy device 30 from which the key was received, as well as information about the type of the hardcopy device 30.

In response to the reception of the key, the management system 20 identifies the data to be printed (step 318). The key received by the key reception unit 250 is passed to the key processing unit 260, which uses the key to identify the applicable data. More particularly, the key processing unit 260 accesses the data storage 220 and uses the key to identify the data to be printed from the data stored in the data storage 220. To make the appropriate identification, the key processing unit 260 can refer to the table in the data storage 220, which matches the key to the applicable data.

In addition to identifying the data to be printed, the management system 20 identifies the print format (step 320). The print format can be included as information passed with the key from the hardcopy device 30. Alternatively, the user may have included the print format to be used when the data was originally sent to the management system 20 and stored in the data storage 220. In such a case, the identified print format may be stored in the data storage 220 and linked to the data to be printed. It is also possible to determine the print format from the identity and type of hardcopy device 30 that transmitted the key to the management system 20. The key processing unit 260 can determine the appropriate print format based on the type of hardcopy device 30, such as by reference to a table that shows a correspondence between the type of hardcopy device 30 and the applicable print format.

Based on the identified print format, the data to be printed is converted into the applicable print format (step 322). The data conversion unit 230 performs the conversion of the data to be printed into the applicable print format. The identified print format can be communicated to the data conversion unit 230 by either the data storage 220 or the data processing unit 260, depending upon the manner in which the print format is identified.

The converted data is then transmitted to the hardcopy device 30 (step 324). The data transmission unit 240 transmits the converted data to the hardcopy device 30. Generally, the data transmission unit 240 determines the hardcopy device to which the converted data is to be transmitted from information identifying the hardcopy device 30 included in the transmission of the key to the management system 20. This identification information can be provided to the data transmission unit 240 by the key processing unit 260. Alternatively, when the data to be printed was originally communicated to the management system 20, the user may have included information identifying the hardcopy device 30 on which the data is to be printed. The hardcopy device 30 receives the converted data from the management system and prints it (step 326). Before the data is printed, it is possible for the user at the hardcopy device 30 to set certain settings of the printing, such as page size, paper source, layout and margins.

In the process described above with respect to FIGS. 3A and 3B, the data to be printed is stored in the management system 20, and in response to the submission of the key to the hardcopy device 30, the management system converts the stored data to a print format and transmits it to the hardcopy device 30, where the converted data is printed. When the data to be printed is originally sent to the management system 20 from the user device, it is possible to include information identifying print format and the hardcopy device 30 upon which the data is to be printed. In such a case, it is possible for the management system 20 to perform the data conversion to the applicable print format and transmit the converted data to the hardcopy device 30 prior to the submission of the key to the hardcopy device 30. The hardcopy device 30 then stores the converted data along with information linking the converted data to the applicable key. When the user submits the key to the hardcopy device 30, the hardcopy device 30 identifies the applicable converted data from the submitted key and prints it.

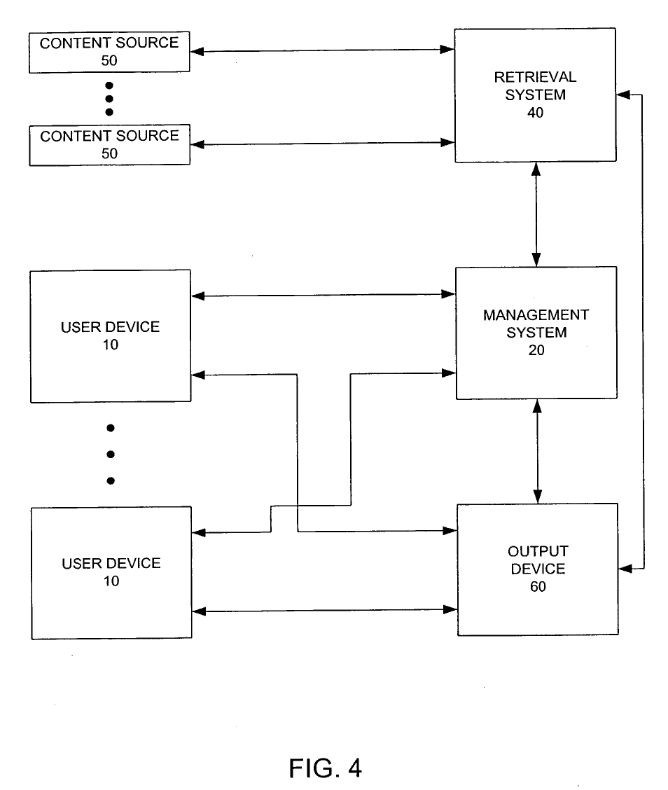

The data processing system of FIG. 1 can be modified to handle other processing tasks in addition to printing data. For example, the data processing system can also process search queries. FIG. 4 is a block diagram of another data processing system consistent with the present invention. As shown in FIG. 4, the data processing system includes one or more user devices 10, the management system 20, a retrieval system 40, content sources 50 and an output device 60. Each of these components can be coupled together by a network connection or by a direct communication connection. The network connection may be implemented by a local network, such as a LAN, or a public network, such as the Internet.

The user device 10 and the management system 20 can be implemented in the same manner as described above with respect to FIG. 1. The retrieval system 40 facilitates the processing of a search query. The retrieval system 40 may be implemented, for example, as a server that receives search queries from the management system 20. The retrieval system 40 may be configured to include a search engine that uses the received search query to identify applicable information. For example, the retrieval system 40 may use search engines such as Google or Yahoo.

Content sources 50 are repositories of data that can be searched by the retrieval system 40. Each content source 50 can be implemented as a database that stores a set of information directed to a particular topic area or a conglomeration of information directed to a wide variety of topic areas. The content source 50 is preferably structured in a manner that enables the quick identification of stored information that is responsive to the search query submitted to the retrieval system 40. For example, the content source can be implemented as a relational database.

The output device 60 can be implemented in the same manner as the hardcopy device 30. In addition to the ability to output hardcopies of data, the output device 60 preferably includes a display and an input device through which the user can input commands to the output device 60, and the output device 60 can display the results of the search query. The output device 60 may also include any other output function through which the user may wish to view the results of the search query. In addition, as described in more detail below, the output device 60 can include a storage area that stores the results of the search query.

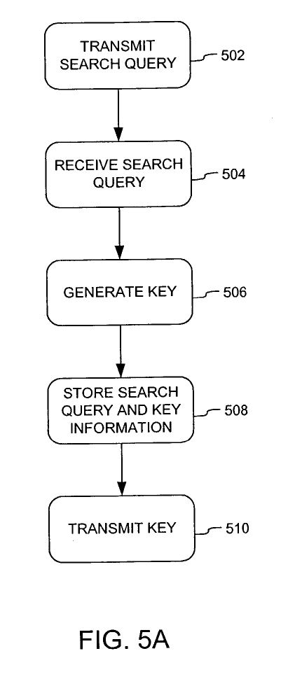

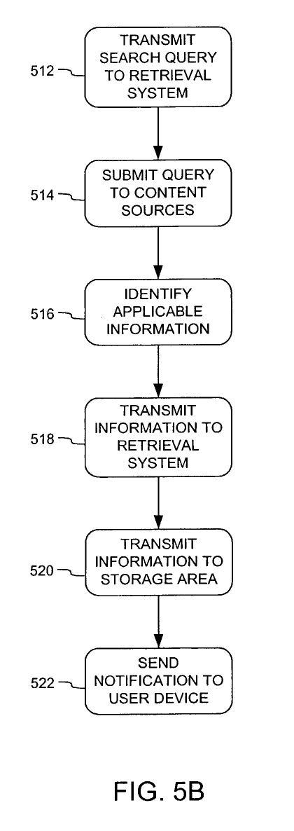

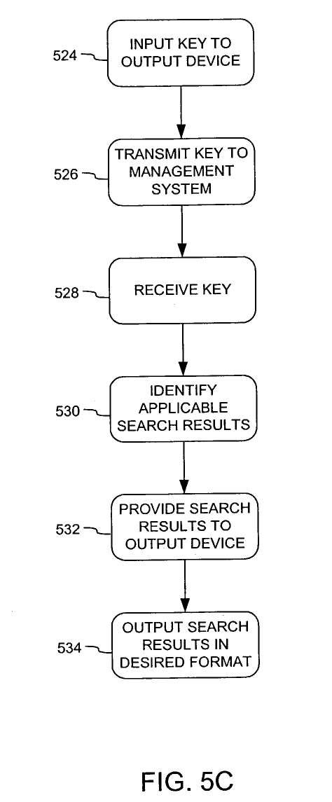

FIGS. 5A-5C are flow diagrams of a process for managing and processing search queries consistent with the present invention. As shown in FIG. 5A, a user transmits a search query to the management system 20 (step 502). The search query is transmitted, e.g., from a user device 10 to the data reception unit 210 of the management system 20 via a communication link, such as a network or direct connection. In addition to the search query, the user can transmit information identifying the content sources 50 that the user wants to search. If there is a fee involved in searching any of the content sources 50, the user may also transmit payment information, such as a credit card, to the management system 20. The information provided by the user may also contain information identifying the output device 60 at which the user will receive the results of the search query.

The search query and related information transmitted by the user are received by the data reception unit 210 of the management system 20 (step 504). The received information is then used to generate a key (step 506) and stored in the data storage 220 of the management system 20 along with the generated key (step 508). The key is generated by the key processing unit 260. The key can be generated by reference to the data received by the data reception unit 210 or by the data stored in the data storage 220. As described above, the key is a unique identifier linked to a particular set of data, such as a search query, received by the management system 20.

As also described above, each search query stored in the data storage 220 is stored in a separate location and preferably includes a name or other identifier linked to the particular search query. In addition to storing the search query, the data storage 220 preferably includes a table that links each particular search query to a key generated by the key processing unit 260. For example, the table can include two columns, with one column for the name of the search query and the other column for the key linked to the search query. This table can be used, as described below, to identify which search query corresponds to a key received by the key reception unit 250.

The key generated by the key processing unit 260 is then transmitted to the user (step 510). The key is transmitted by the key transmission unit 270 to the user device 10 that transmitted the search query to which the key is linked. The key transmitted to the user device 10 may be stored in a non-volatile storage area. The non-volatile storage area can be, for example, an NVRAM of a PC, mobile telephone or PDA or on a strip of a magnetic card.

Referring to FIG. 5B, after receiving the search query from the user, the management system 20 transmits the search query to the retrieval system 40 (step 512). The search query can be transmitted by the data transmission unit 240 of the management system 20. The transmission of the search query may be via a network connection, such as through the Internet, or by a direct connection between the management system 20 and the retrieval system 40.

The retrieval system 40 submits the received search query to the content sources 50 (step 514). In addition to the search query, the retrieval system 40 may also receive information from the management system 20 that identifies content sources 50 to which the search query is to be submitted. Alternatively, if specific content sources are not identified, the retrieval system 40 can submit the query to a default group of one or more content sources 50.

Each content source 50 receiving the search query from the retrieval system 40 identifies information that is responsive to the search query (step 516). The manner in which information is identified in response to a search query is well known in the art. The information identified by the content sources 50 corresponds to the results of the search query, which are provided to the retrieval system 40 that submitted the search query (step 518). The retrieval system 40 then transmits the results of the search query to a storage area (step 520). The storage area may be located in the management system 20, at the output device 60, or some other location accessible to the retrieval system 40, management system 20 and output device 60.

If the results of the search query are not transmitted for storage in the management system 20, the retrieval system 40 preferably sends an indication or notification to the management system 20 that the search query process has been completed. The notification can also include information identifying where the search results are being stored. Information of the location of the search results can be stored in the data storage 220 and included in the table linking the key to the search query. If the results of the search query are stored in the management system 20, then the indication that the search is complete is evident from the receipt of the results. In response to the notification that the search is complete, the management system 20 sends a notification to the user that the search is complete (step 522). The notification may be sent as an e-mail to the user device 10 that submitted the search query. Alternatively, if the user device 10 includes a mobile phone, the management system 20 can send an automatic voice message to the mobile phone indicating that the search is complete.

Referring to FIG. 5C, after the user receives the notification that the search has been completed, the user can then go to the output device to collect the search results. To collect the search results, the user inputs the key received from the management system 20 to the output device 60 (step 524). The manner in which the user inputs the key depends upon the implementation of the user device 10 upon which the key is stored. For example, if the key is stored on a magnetic card, the user can input the key by swiping the card on a card reader implemented on the output device 60. Alternatively, if the user device 10 is a PDA, the user can input the key by placing the PDA on a cradle implemented on the output device 60 or by connecting a cable to link the PDA and the hardcopy device 30. The user device 10 and output device 60 can also be coupled together via a wireless link.

If more than one search query was transmitted to the management system 20, then it is possible that the user device 10 may have more than one key. In this case, each of the keys stored in the user device 10 may be inputted to the output device 60. The output device 60 can then list each of the keys to the user, and the user selects the key for the search results that the user wishes to collect. To facilitate this listing, the key may include a name or identifier of the search query. If included, the name or identifier can be displayed to the user so the user knows which search query results will be displayed. Without the name or identifier, the user may not be able to easily determine which search query corresponds to which key, which may simply be a unique numerical value.

The key received by the output device 60 is transmitted to the management system 20 (step 526). The key is transmitted to the management system 20 in accordance with the communication link between the management system 20 and the output device 60. The communication link may be a network connection, such as via the Internet or LAN, or a direct connection, such as USB. The key is received by the key reception unit 250 of the management system 20 (step 528). In addition to the key, the management system 20 may receive information identifying the output device 60 from which the key was received.

In response to the reception of the key, the management system 20 identifies the applicable search query results (step 530). The key received by the key reception unit 250 is passed to the key processing unit 260, which uses the key to identify the applicable search query results. More particularly, the key processing unit 260 accesses the data storage 220 and uses the key to identify the applicable search results from the data stored in the data storage 220. To make the appropriate identification, the key processing unit 260 can refer to the table in the data storage 220, which matches the key to the applicable search query.

The search query results corresponding to the key received by the management system 20 are transmitted to the output device 60 (step 532). If the search query results are stored in the management system 20, then they can be transmitted directly from the management system 20 to the output device 60. If the search query results are stored in a storage area separate from the management system 20, then the management system 20 identifies the location of the search query results, such as from a table stored in the data storage 220, and directs that search query results at the identified location be transmitted to the output device 60. If the search query results are stored in a storage area of the output device 60, then it is unnecessary for the search query results to then be transmitted to the output device 60.

The applicable search query results are provided to the user at the output device 60 in a manner desired by the user (step 534). For example, the user may elect to have the search query results displayed on a display of the output device 60. Alternatively, the user may elect to have the search query results printed as a hardcopy listing the results. The search query results can also be downloaded to the user device 10 and stored in a storage area of the user device 10 from which they can be displayed to the user.

As described above, with respect to processing print jobs, the process of converting data to be printed into a printable format is done by the management system 20 instead of the hardcopy device. This shift in the location of where the conversion is done results in a time savings for the hardcopy device, which can operate more efficiently by spending more time printing data instead of converting data into a printable format. In addition, all of these operation can take place remotely among the user, the management system 20 and the output device upon which the data is printed.

With respect to processing search queries, instead of submitting a search query directly to a retrieval system, a user submits a search query to the management system 20, which forwards it to the retrieval system 40. While the search query is being processed, the user is free to submit one or more search queries instead of waiting for the completion of the initial search query. In addition, all of these operation can take place remotely among the user, the management system 20, the retrieval system 40 and the output device upon which the results of the search query can be viewed and printed.

The foregoing description of preferred embodiments of the invention has been presented for purposes of illustration and description only. It is not intended to be exhaustive or to limit the invention to the precise form disclosed, and modifications and variations are possible and/or would be apparent in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto and that the claims encompass all embodiments of the invention, including the disclosed embodiments and their equivalents.

What is claimed is:

1. A method for processing data to be printed, comprising:
receiving data to be printed from a user via a network connection;
generating a unique identifier in response to the reception of the data from the user, the unique identifier being related to the received data;
transmitting the unique identifier to the user via the network connection;
translating the received data into a printable format in accordance with a format suitable for a printing device on which the received data is to be printed; and
transmitting the received data in the printable format to the printing device on which the received data is to be printed.

2. A method according to claim 1, further comprising receiving the unique identifier from the printing device via a network connection,
wherein the received data in the printable format is transmitted to the printing device in response to the reception of the unique identifier from the printing device.

3. A method according to claim 1, further comprising receiving the unique identifier from the printing device via a network connection,
wherein the received data is translated into the printable format in response to the reception of the unique identifier from the printing device and based on information from the printing device identifying the printable format.

4. A method according to claim 1, wherein the unique identifier is one of a bar code and a numerical value.

5. A method according to claim 1, wherein the unique identifier includes information identifying the received data.

6. A method according to claim 1, further comprising maintaining a table that links the received data with the unique identifier.

7. A method according to claim 1, wherein the data received from the user includes information identifying the printing device on which the data is to be printed.

8. A method for providing results of a search to a user, comprising:
receiving a search query from the user via a network connection;
generating a unique identifier corresponding to the search query received from the user;
transmitting the unique identifier to the user via the network connection;
submitting the search query to a retrieval system to conduct a search in accordance with the search query;
storing the results of the search in a storage area; and
providing the results of the search at an output device in response to the reception of the unique identifier from the output device.

9. A method according to claim 8, further comprising:
receiving a notification that the search by the retrieval system has been completed; and
sending a notification to the user that the search by the retrieval system has been completed.

10. A method according to claim 9, further comprising:
receiving an indication from the user identifying one or more content sources with which to conduct the search,
wherein the submitting includes submitting the search query to the one or more content sources identified in the indication.

11. A management system for processing data to be printed, comprising:
a data reception unit which receives data to be printed from a user via a network connection;
a key processing unit which generates a unique identifier in response to the reception of the data from the user, the unique identifier being related to the received data;
a key transmission unit which transmits the unique identifier to the user via the network connection;
a data conversion unit which translates the received data into a printable format in accordance with a format suitable for a printing device on which the received data is to be printed; and
a data transmission unit which transmits the received data in the printable format to the printing device on which the received data is to be printed.

12. A management system according to claim 1 1, further comprising a key reception unit which receives the unique identifier from the printing device via a network connection,
wherein the received data in the printable format is transmitted to the printing device by the data transmission unit in response to the reception of the unique identifier by the key reception unit from the printing device.

13. A management system according to claim 11, further comprising receiving the unique identifier from the printing device via a network connection,
wherein the received data is translated into the printable format by the data conversion unit in response to the reception of the unique identifier by the key reception unit from the printing device and based on information from the printing device identifying the printable format.

14. A management system according to claim 11, wherein the unique identifier is one of a bar code and a numerical value.

15. A management system according to claim 11, wherein the unique identifier includes information identifying the received data.

16. A management system according to claim 11, further comprising a data storage unit which maintains a table that links the received data with the unique identifier.

17. A management system according to claim 11, wherein the data received from the user includes information identifying the printing device on which the data is to be printed.

18. A management system for providing results of a search to a user, comprising:
a data reception unit which receives a search query from the user via a network connection;
a key processing unit which generates a unique identifier corresponding to the search query received from the user;
a key transmission unit which transmits the unique identifier to the user via the network connection;
a data transmission unit which submits the search query to a retrieval system to conduct a search in accordance with the search query;
a data storage unit which stores the results of the search in a storage area; and
a key reception unit which receives the unique identifier from the output device,
wherein the data transmission unit provides the results of the search at the output device in response to the reception of the unique identifier by the key reception unit from the output device.

19. A management system according to claim 18, wherein the data reception unit receives a notification that the search by the retrieval system has been completed, and the data transmission unit sends a notification to the user that the search by the retrieval system has been completed.

20. A management system according to claim 19, wherein the data reception unit receives an indication from the user identifying one or more content sources with which to conduct the search, and the data reception unit submits the search query to the one or more content sources identified in the indication.

21. A hardcopy device for printing data, comprising:
an input unit which receives a unique identifier from a user, the unique identifier being related to data to be printed specified by the user;
a transmission unit which transmits the unique identifier received by the input unit to a storage unit storing the data to be printed;
a reception unit which receives the data to be printed from the storage unit in response to the transmission of the unique identifier; and
a printing unit which prints the data received by the reception unit.

22. A hardcopy device according to claim 21, wherein the transmission unit transmits information identifying a printable format for the hardcopy device to the storage unit.

23. A hardcopy device according to claim 22, wherein the data received by the reception unit is in the printable format identified by the information transmitted by the transmission unit.

24. A hardcopy device according to claim 21, wherein the unique identifier is one of a bar code and a numerical value.

25. A hardcopy device according to claim 21, wherein the unique identifier includes information identifying the data to be printed.
